(19) United States
(12) Patent Application Publication
(10) Pub. No.: US 2010/0039824 A1
(43) Pub. Date: Feb. 18, 2010

(54) LIGHTING DEVICE CAPABLE OF PROJECTING AN OUTPUT WITH A RING BAND PORTION

(75) Inventor: Yu-Chieh Wang, Yung-Kang City (TW)

Correspondence Address: VISTA IP LAW GROUP LLP, 12930 Saratoga Avenue, Suite D-2, Saratoga, CA, 95070, US

(73) Assignee: Maxzone Vehicle Lighting Corp., Fontana, CA (US)

(21) Appl. No.: 12/192,327

(22) Filed: Aug. 15, 2008

(51) Int. Cl. F21V 7/10

(52) U.S. Cl. 362/310

(57) ABSTRACT

A lighting device includes a secondary lamp casing having an inner ring portion connected to a peripheral portion of a primary lamp casing, an outer ring portion surrounding the inner ring portion, and an annular reflector wall extending between the ring portions. The reflector wall has at least one source mounting section having a reflecting surface with angularly spaced apart ends, an intermediate part between the spaced apart ends, and two sets of curved surface segments. The curved surface segments in each set are interconnected in sequence from the intermediate part to a respective one of the spaced apart ends, and are different paraboloid segments that have coaxial focal axes. A primary light source is mounted to and extends into the primary lamp casing. A secondary light source is disposed at the intermediate part of the source mounting section.

### BACKGROUND OF THE INVENTION

1. Field of the Invention

The invention relates to a lighting device, more particularly to a lighting device capable of projecting an output with a ring band portion.

2. Description of the Related Art

Referring to FIG. 1, U.S. Pat. No. 7,144,144 discloses a conventional vehicle light 1 that includes a reflector 11, a reflection member 12, a lamp unit 13, a light-transmissible release ring 14, and a cover plate 15. The reflector 11 surrounds an axis. The reflection member 12 surrounds the reflector 11 and the axis. Each of the reflector 11 and the reflection member 12 has an inner reflection surface 111, 121. The lamp unit 13 includes a main lamp 131 mounted to and extending into the reflector 11 along the axis, and three sub-lamps 132 mounted to and extending into the reflection member 12. The release ring 14 is used to cover one side of the reflection member 12.

In use, a portion of light from the main lamp 131 passes directly through the cover plate 15, and a portion of light from the sub-lamps 132 passes directly through the release ring 14 and the cover plate 15. Another portion of the light from the main lamp 131 and the sub-lamps 132 is reflected by the inner reflection surface 111 or 121 before passing through the cover plate 15 or through the release ring 14 and the cover plate 15. The main lamp 131 is used for near-field illumination. The sub-lamps 132 are used to provide a ring band output suitable for far-field illumination.

The inner reflection surface 121 includes three recessed areas where the sub-lamps 132 are respectively disposed. Each of the recessed areas is defined by a curved surface. With further reference to FIG. 2, light from the sub-lamps 132 is reflected by the inner reflection surface 121 with scattering, which diminishes the intensity of the ring band output.

### SUMMARY OF THE INVENTION

Therefore, the object of the present invention is to provide a lighting device that can overcome the above drawback associated with the prior art.

Accordingly, a lighting device of the present invention comprises a primary lamp casing, a secondary lamp casing, a primary light source, and a secondary light source.

The primary lamp casing has a peripheral portion that surrounds a primary axis. The secondary lamp casing includes an inner ring portion that is connected to the peripheral portion of the primary lamp casing, an outer ring portion that surrounds the inner ring portion and that cooperates with the inner ring portion to form an annular space, and an annular reflector wall extending between the inner and outer ring portions, closing one end of the annular space, and surrounding the primary axis. The reflector wall has at least one source mounting section. The source mounting section has a reflecting surface that confronts the annular space and that has angularly spaced apart ends, an intermediate part between the spaced apart ends, and two sets of curved surface segments. The curved surface segments in each of the sets are interconnected in sequence from the intermediate part to a respective one of the spaced apart ends, and are different paraboloid segments that have coaxial focal axes to thereby configure the reflecting surface of the source mounting section with a series of steps from each of the spaced apart ends to the intermediate part. The primary light source is mounted to and extends into the primary lamp casing. The secondary light source is disposed at the intermediate part of the reflecting surface of the source mounting section of the reflector wall of the secondary lamp casing, and extends into the annular space such that a portion of light emitted by the secondary light source is reflected by the curved surface segments of the reflecting surface to travel in directions parallel to the primary axis so that an output projected by the lighting device includes a ring band portion.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional vehicle light disclosed in U.S. Pat. No. 7,144,144;

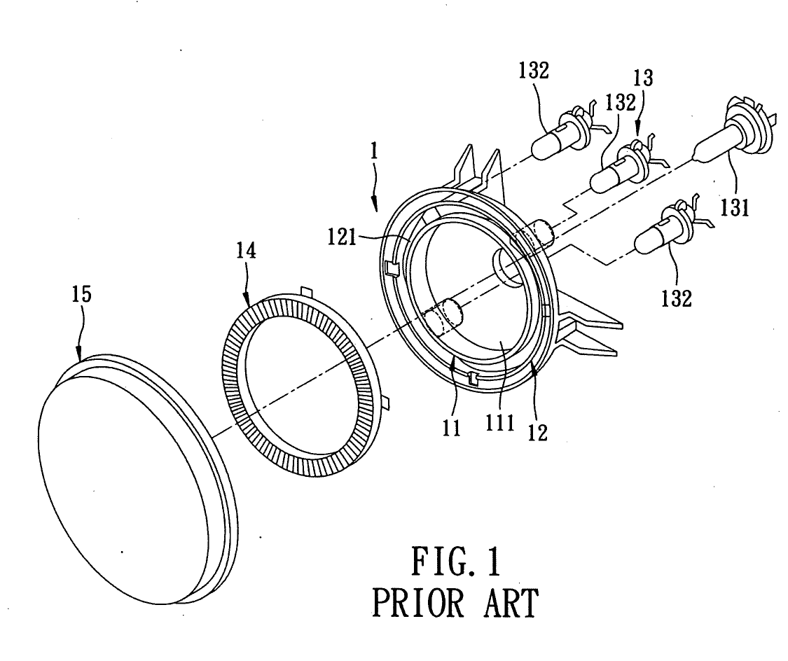

FIG. 2 is a fragmentary assembled sectional view of the conventional vehicle light to illustrate scattering of light emitted by a sub-lamp upon reflection by a reflection member;

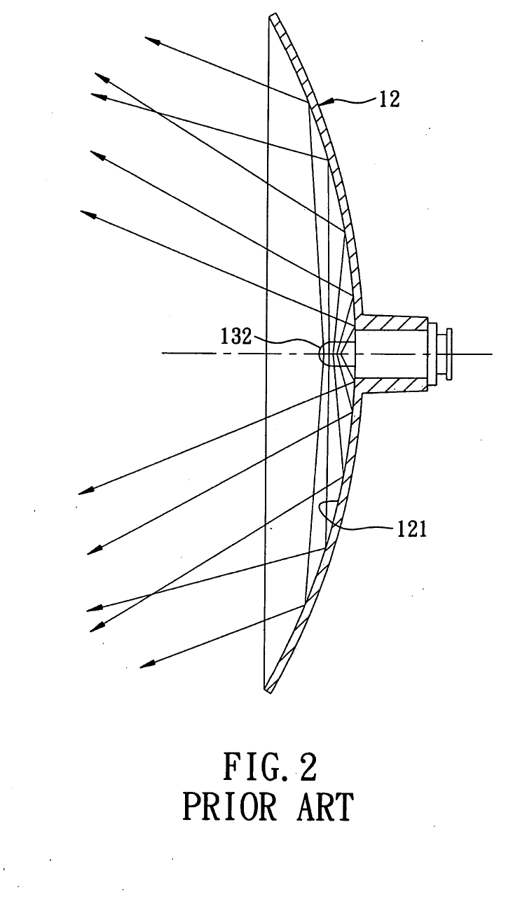

FIG. 3 is an exploded perspective view of the preferred embodiment of a lighting device according to the present invention;

FIG. 4 is a schematic perspective view to illustrate an annular reflector wall of a secondary lamp casing of the preferred embodiment;

FIG. 5 is a fragmentary sectional view to illustrate how a portion of light emitted by a secondary light source is reflected by a corresponding source mounting section of the reflector wall;

FIG. 6 is an end view of the preferred embodiment with an annular lens and a main lens removed;

FIG. 7 is a sectional view of the preferred embodiment, taken along lines VII-VII in FIG. 6; and

FIG. 8 is a partly exploded sectional view of a modification of the preferred embodiment.

### DETAILED DESCRIPTION OF THE PREFERRED EMBODIMENT

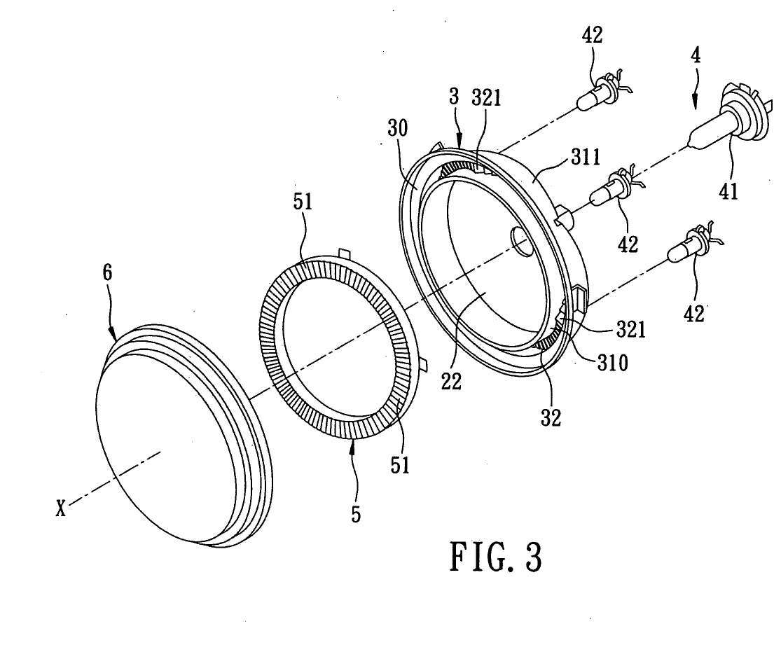

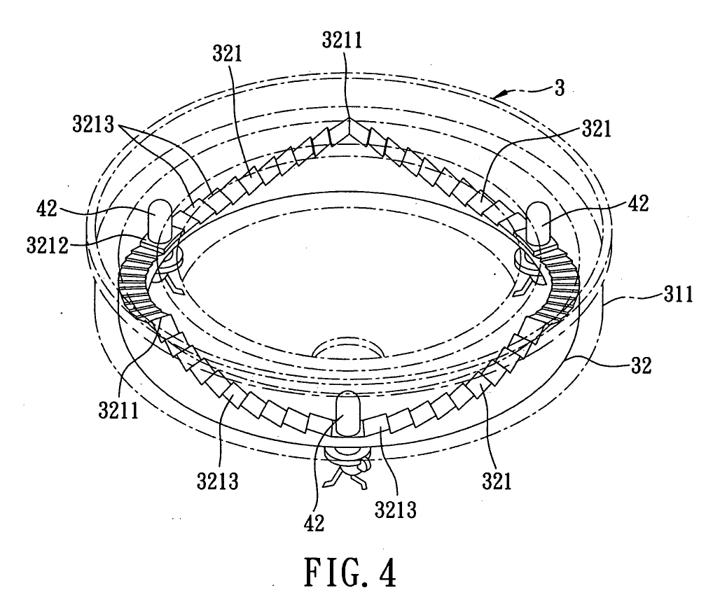

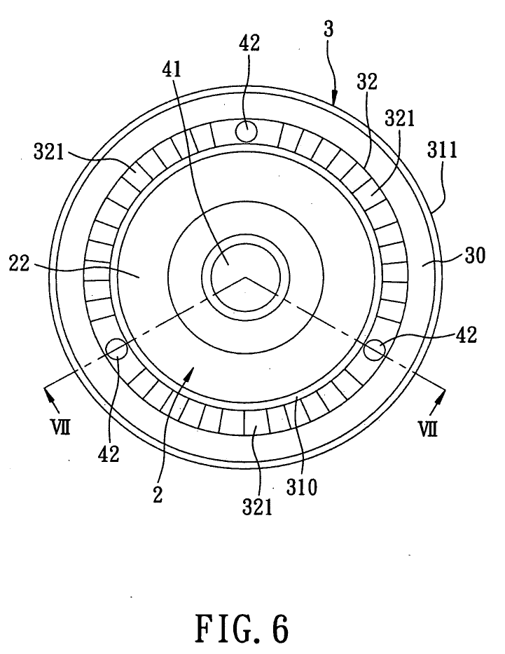

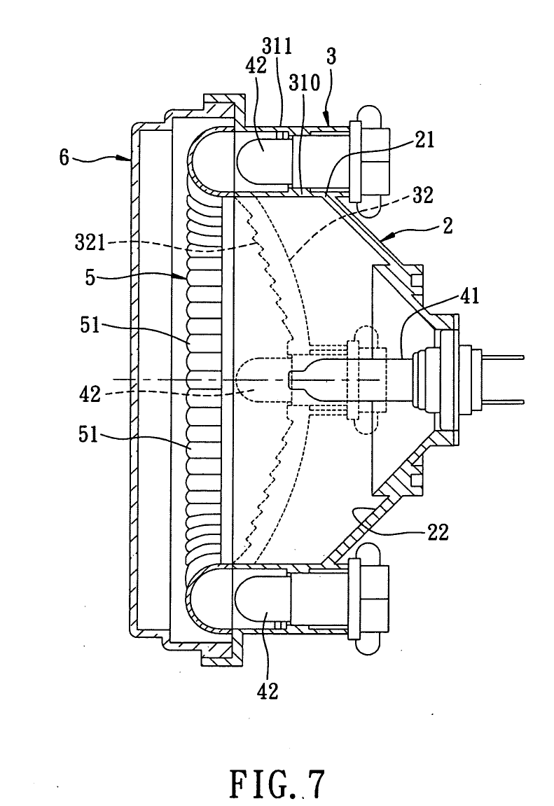

Referring to FIGS. 3 to 7, the preferred embodiment of a lighting device according to the present invention includes a primary lamp casing 2, a secondary lamp casing 3, a light source unit 4, an annular lens 5, and a main lens 6. In this embodiment, the light source unit 4 includes a primary light source 41 and three secondary light sources 42.

The primary lamp casing 2 has a peripheral portion 21 that surrounds a primary axis (X), and a paraboloid reflecting portion 22.

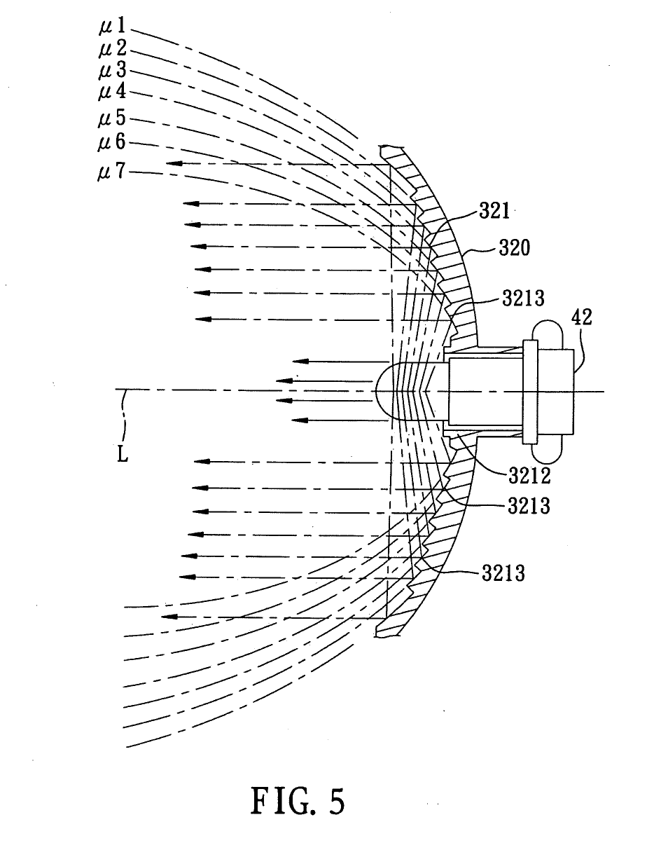

The secondary lamp casing 3 includes an inner ring portion 310 that is connected to the peripheral portion 21 of the primary lamp casing 2, an outer ring portion 311 that surrounds the inner ring portion 310 and that cooperates with the inner ring portion 310 to form an annular space 30, and an annular reflector wall 32 extending between the inner and outer ring portions 310, 311, closing one end of the annular space 30, and surrounding the primary axis (X). In this embodiment, the reflector wall 32 has three source mounting sections 320 that cooperate to surround the primary axis (L). Each source mounting section 320 has a reflecting surface 321 that confronts the annular space 30 and that has angularly spaced apart ends 3211, an intermediate part 3212 between the spaced apart ends 3211, and two sets of curved surface segments 3213. The curved surface segments 3213 in each of the sets are interconnected in sequence from the intermediate part 3212 to a respective one of the spaced apart ends 3211, and are different paraboloid segments that have coaxial focal axes to thereby configure the reflecting surface 321 of the source mounting section 320 with a series of steps from each of the spaced apart ends 3211 to the intermediate part 3212. As shown in FIG. 5, seven of the curved surface segments 3213 in each set are different paraboloid segments (μ1-μ7) that have coaxial focal axes (L), and the paraboloid segments (μ1-μ7) corresponding to interconnected ones of the curved surface segments 3213 are uniformly spaced apart.

The primary light source 41 is mounted to and extends into the primary lamp casing 2 along the primary axis (X).

Each of the secondary light sources 42 is disposed at the intermediate part 3212 of the reflecting surface 321 of a respective one of the source mounting sections 320 of the reflector wall 32 of the secondary lamp casing 3, and extends into the annular space 30 such that a portion of light emitted by the secondary light sources 42 is reflected by the curved surface segments 3213 of the reflecting surfaces 321 to travel in directions parallel to the primary axis (X) so that an output projected by the lighting device includes ring band portions. In this embodiment, the secondary light sources 42 are equiangularly spaced apart with respect to the primary axis (X), and the focal axes (L) of the paraboloid segments (μ1-μ7) corresponding to the curved surface segments 3213 of the reflecting surface 321 of each source mounting region 320 pass through the respective secondary light source 42 disposed thereat. Preferably, the primary light source 41 is one of a light bulb and a light emitting diode, and each of the secondary light sources 42 is also one of a light bulb and a light emitting diode.

The annular lens 5 is made of a light-transmissible material, is mounted to the secondary lamp casing 3 to close the other end of the annular space 30, and has a textured outer surface formed with a plurality of protrusions 51.

The main lens 6 is made of a light-transmissible material, and serves to cover an assembly of the primary lamp casing 2 and the secondary lamp casing 3.

In use, a portion of light from the primary light source 41 passes directly through the main lens 6. Another portion of the light from the primary light source 41 is reflected by the reflecting portion 22 before passing through the main lens 6. The output projected by the lighting device as a result of operation of the primary light source 41 is suitable for near-field illumination.

On the other hand, a portion of light from the secondary light sources 42 passes directly through the annular lens 5 and the main lens 6. Another portion of the light from the secondary light sources 42 is reflected by the curved surface segments 3213 to travel in directions parallel to the primary axis (X) before passing through the annular lens 5 and the main lens 6. Because light is reflected to travel in directions parallel to the primary axis (X), a high intensity output can be achieved. The output projected by the lighting device as a result of operation of the secondary light sources 42 thus has noticeable ring band portions and is suitable for far-field illumination.

In view of the higher light utilization efficiency that can be achieved through the presence of the curved surface segments 3213, lower-wattage secondary light sources 42 can be used to reduce power consumption while maintaining the desired output intensity.

It is noted herein that the annular lens 5 can have different colors so as to form ring band portions in different colors. Moreover, different patterns and shapes of the protrusions 51 of the annular lens 5 may be used to provide diverse visual effects.

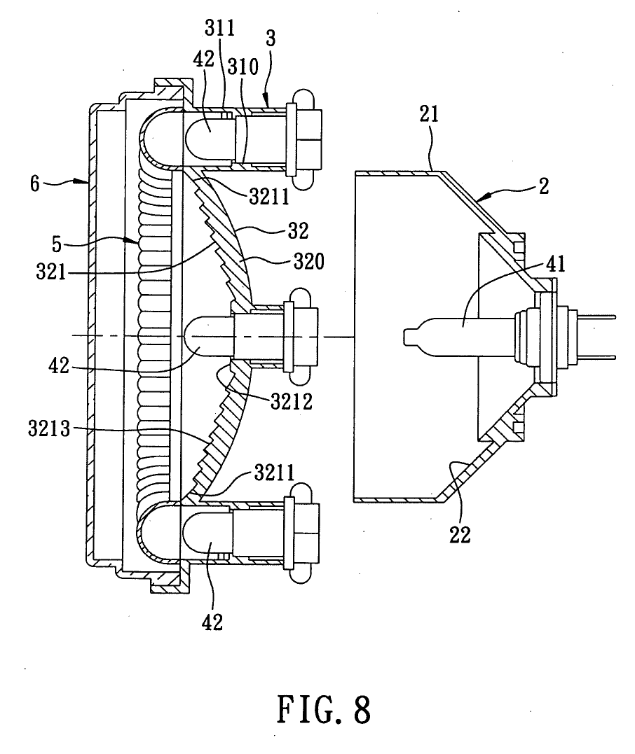

Furthermore, while the primary lamp casing 2 and the secondary lamp casing 3 are integrally formed in the preferred embodiment, this should not be imposed as a limitation in practice. As shown in FIG. 8, the primary lamp casing 2 is formed separate from the secondary lamp casing 3, and the peripheral portion 21 of the primary lamp casing 3 is tubular and extends along a periphery of the reflecting portion 22. The peripheral portion 21 is attached to the inner ring portion 310 of the secondary lamp casing 31 using known techniques, such as with the use of an adhesive.

It is also noted that the number of the secondary light sources 42 can vary depending on actual requirements.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A lighting device comprising:
a primary lamp casing having a peripheral portion that surrounds a primary axis;
a secondary lamp casing including an inner ring portion that is connected to said peripheral portion of said primary lamp casing, an outer ring portion that surrounds said inner ring portion and that cooperates with said inner ring portion to form an annular space, and an annular reflector wall extending between said inner and outer ring portions, closing one end of said annular space, and surrounding the primary axis, said reflector wall having at least one source mounting section, said source mounting section having a reflecting surface that confronts said annular space and that has angularly spaced apart ends, an intermediate part between said spaced apart ends, and two sets of curved surface segments, said curved surface segments in each of said sets being interconnected in sequence from said intermediate part to a respective one of said spaced apart ends and being different paraboloid segments having coaxial focal axes to thereby configure said reflecting surface of said source mounting section with a series of steps from each of said spaced apart ends to said intermediate part;
a primary light source mounted to and extending into said primary lamp casing; and
a secondary light source disposed at said intermediate part of said reflecting surface of said source mounting section of said reflector wall of said secondary lamp casing and extending into said annular space such that a portion of light emitted by said secondary light source is reflected by said curved surface segments of said reflecting surface to travel in directions parallel to the primary axis so that an output projected by said lighting device includes a ring band portion.

2. The lighting device as claimed in claim 1, wherein the paraboloid segments corresponding to interconnected ones of said curved surface segments are uniformly spaced apart.

3. The lighting device as claimed in claim 1, wherein said reflector wall has three of said source mounting sections that cooperate to surround the primary axis, and said lighting device comprises three of said secondary light sources, each of which is disposed at a respective one of said source mounting sections.

4. The lighting device as claimed in claim 3, wherein said secondary light sources are equiangularly spaced apart with respect to the primary axis.

5. The lighting device as claimed in claim 1, wherein the focal axes of the paraboloid segments corresponding to the curved surface segments pass through said secondary light source at said source mounting section.

6. The lighting device as claimed in claim 1, wherein said primary light source is one of a light bulb and a light emitting diode.

7. The lighting device as claimed in claim 1, wherein said secondary light source is one of a light bulb and a light emitting diode.

8. The lighting device as claimed in claim 1, further comprising an annular lens mounted to said secondary lamp casing to close the other end of said annular space.

9. The lighting device as claimed in claim 1, further comprising a main lens to cover an assembly of said primary lamp casing and said secondary lamp casing.

10. The lighting device as claimed in claim 1, wherein said primary lamp casing further includes a paraboloid reflecting portion.

11. The lighting device as claimed in claim 10, wherein said peripheral portion is tubular and extends along a periphery of said reflecting portion.

12. The lighting device as claimed in claim 1, wherein said primary light source extends into said primary lamp casing along the primary axis.
